(19) United States
(12) Patent Application Publication
(10) Pub. No.: US 2009/0206197 A1
(43) Pub. Date: Aug. 20, 2009

(54) Actuator and flap arrangement with actuator interconnection

(75) Inventors: Arthur Degenholtz, Teaneck, NJ (US); Edward Mayer, West Orange, NJ (US); Naresh P. Vaghela, Bradley Stoke (GB)

Correspondence Address: PEARNE & GORDON LLP, 1801 EAST 9TH STREET, SUITE 1200, CLEVELAND, OH, 44114-3108, US

(73) Assignee: Curtiss-Wright Controls, Inc., Gastonia, NC (US)

(21) Appl. No.: 11/440,558

(22) Filed: May 25, 2006

Related U.S. Application Data
(63) Continuation-in-part of application No. 10/413,242, filed on Apr. 14, 2003, now abandoned.

(51) Int. Cl. B64C 9/00

(52) U.S. Cl. 244/99.3

(57) ABSTRACT

An actuator and flap arrangement includes a flap, movable relative to a support structure, and two actuators. Each actuator has a portion fixed relative to the support structure, a portion movable relative to the fixed portion and connected to the flap for transfer of motor force to flap upon movement of the movable portion, and a motor for moving the movable portion relative to the fixed portion. The arrangement also includes a device interconnecting the two actuators for transferring motive force between the two actuators.

### RELATED APPLICATIONS

This application is a continuation-in-part of prior U.S. Non-Provisional application Ser. No. 10/413,242, filed on Apr. 14, 2003, the entire disclosure of which is hereby incorporated herein by reference.

### FIELD OF THE INVENTION

The present invention relates to a movable flap, such as a lift flap of an aircraft, and actuators that are employed to move the flap.

### BACKGROUND OF THE INVENTION

Many vehicles, such as aircraft, include one or more movable flaps. For example, an aircraft wing may include a plurality of flaps located along a trailing edge of the wing. Movement or motion of the flaps results in changes in directional flow of fluid (e.g., air in the case of an aircraft wing) and thus fluid pressure applied to the flaps. For a flap located on a wing, movement of the flap results in changes of the amount of lift provided by the wing.

Within the example of an aircraft wing, a plurality of passive actuators is utilized to move one or more flaps. In one example, the actuators are driven by a plurality of torque shafts. In turn, the torque shafts are driven from a central power drive unit. Such a drive unit may be a hydraulic unit or an electric powered unit, or may even by a combination of hydraulic and electric components.

For optimum mechanical efficiency, the actuators, the torque shafts, and the power drive unit would be mounted along a straight line. However, such an ideal situation is seldom encountered. Other wing-mounted structure typically hinders the ability to have a straight line mounting. As such, in common practice, this results in a relatively large number of angle gearboxes and “T” gear boxes within a drive chain for the plural actuators within a wing. Also, the torque shafts also require various torque shaft support bearings to prevent excessive deflection during operation. The above issues become magnified with an increasing number of movable flaps, an increasing number of actuators, and increasing number of torque shafts, and an increasingly torturous path for the drive train due to other wing-mounted structure, etc.

Such structures and complexities are counter productive with regard to common design desires concerning reductions in size, weight, and system complexity. Such counteracting considerations become especially poignant when utilized within a high-lift wing arrangement for modern, sophisticated aircraft.

### SUMMARY OF THE INVENTION

In accordance with one aspect, the invention provides an actuator and flap arrangement. The arrangement includes a flap movable relative to a support structure. The arrangement includes two actuators. Each actuator has a portion fixed relative to the support structure, a portion movable relative to the fixed portion and connected to the flap for transfer of motor force to flap upon movement of the movable portion, and a motor for moving the movable portion relative to the fixed portion. The arrangement also includes a device interconnecting the two actuators for transferring motive force between the two actuators.

### BRIEF DESCRIPTION OF THE DRAWINGS

The forgoing and other features and advantages of the present invention will become apparent to the person of ordinary skill in the art upon reading the following the following description in view of the accompanying drawings in which:

FIG. 1 is a block diagram of a multi-flap system that utilizes at least one arrangement in accordance with the present invention;

FIG. 2 is a block diagram of a known flap actuation system in which several actuators are driven by a single, remotely-located motor;

FIG. 3 is a partially sectioned view of a sample containing two actuators and a torque shaft as part of an arrangement in accordance with the present invention;

FIG. 4 is a partially sectioned view showing greater detail of an example of an actuator of the partial arrangement shown within FIG. 3;

FIG. 5 is a partially sectioned view showing greater detail of an example of another actuator in accordance with an aspect of the present invention;

FIG. 6 is a partially sectioned view showing greater detail of an example of yet another actuator in accordance with yet another aspect of the present invention.

FIG. 7A is a partially sectioned view of a sample containing two actuators and a torque shaft as part of another arrangement in accordance with the present invention;

FIG. 7B is similar to FIG. 7A, but shows yet another arrangement in accordance with the present invention; and

FIG. 7C is similar to FIG. 7A, but shows still yet another arrangement in accordance with the present invention.

### DESCRIPTION OF EXAMPLE EMBODIMENTS

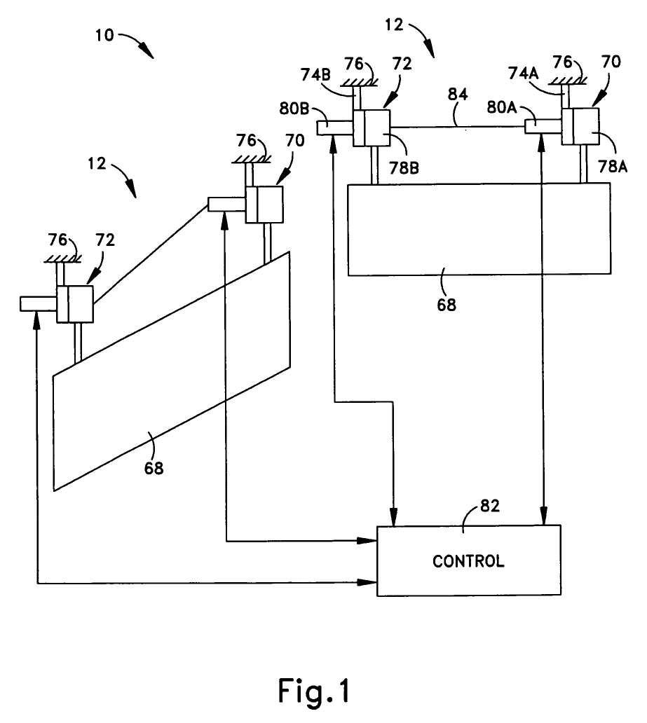

A flap actuation system 10 in accordance with the present invention is schematically shown in FIG. 1. In the disclosed example, the system 10 is part of an aircraft and is specifically located on a wing of the aircraft. Two example actuator and flap arrangements 12 of the system 10 are shown.

It is to be appreciated that the system may have a different configuration, for example a different number of actuator and flap arrangements. In addition or alternatively, the two arrangements 12 may have similar or different mechanical construction. Due to the similarity within the shown example, only one arrangement 12 is discussed in detail with the understanding that identical or similar structure is present for the other arrangement. However, in accordance with the present invention, the system 10 and each of the arrangements 12 provide distinctions and advantages over conventional flap actuation systems.

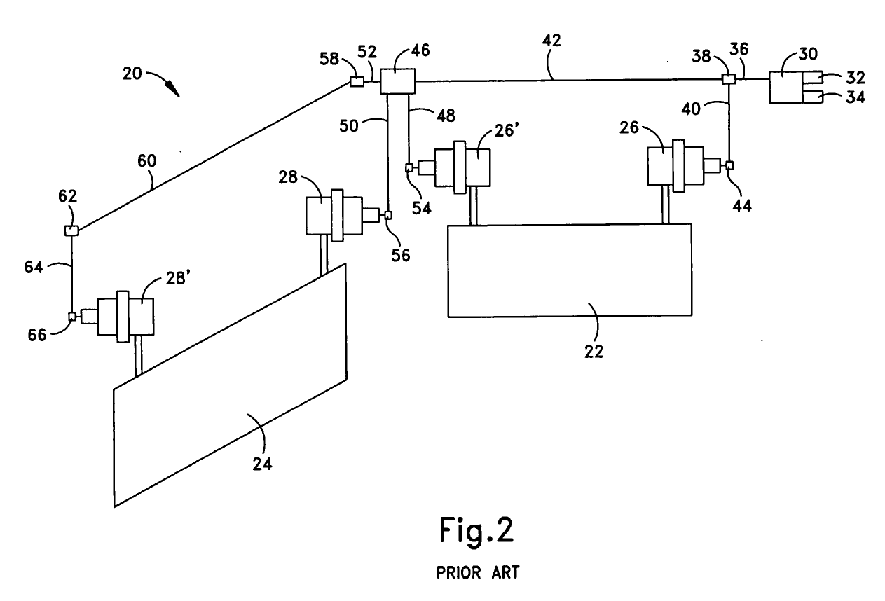

In order to appreciate these distinctions and advantages, one example of such a conventional flap actuation system 20 is shown within FIG. 2. The system 20 is part of an aircraft and is specifically located on a wing of the aircraft. Two movable flaps 22, 24 on the wing are shown within the system 20. Within the wing and associated with the flaps are two pairs of ball-screw actuators 26, 26′, and 28, 28′. Each pair of actuators (e.g., 26, 26′) is operatively connected to the associated flap (e.g., 22).

A power drive unit 30 is also provided within the wing. The power drive unit 30 includes an electric motor 32 and a hydraulic motor 34 and has an output shaft 36. The power drive unit 30 provides motive force for operation of the four actuators 26, 26′, 28, and 28′, and thus movement of the flaps 22, 24.

A plurality of torque shafts, gear boxes, and other structures are provided within the wing to transfer the motive force from the power drive unit 30 to the actuators 26, 26′, 28, and 28′. In the shown example, the output shaft 36 of the power drive unit 30 is connected to a first gear box 38. In turn, the first gear box 38 is connected to first and second torque shafts 40 and 42, respectively. The first torque shaft 40 is connected to a second gear box 44, which is in turn connected to an input of the first actuator 26.

The second torque shaft 42 is connected to a third gear box 46. Third, fourth, and fifth torque shafts, 48-52, respectively, extend from the third gear box 46. The third torque shaft 48 extends to a fourth gear box 54, which, in turn, is connected to an input of the second actuator 26′. The fourth torque shaft 50 extends to a fifth gear box 56, which, in turn, is connected to an input of the third actuator 28. The fifth torque shaft 52 is connected to a sixth gearbox 58, which is an angle gear box. A sixth torque shaft 60 extends between the sixth gearbox 58 and a seventh gearbox 62, which also is an angle gearbox. A seventh torque shaft 64 extends between the seventh gearbox 62 and an eighth gearbox 66, which is, in turn, connected to an input of the fourth actuator 28′.

It is to be appreciated that the motive forces for all of the actuators 26, 26′, 28, and 28′ are supplied by the single drive unit 30. As such, all of the actuators 26, 26′, 28, and 28′ are passive devices. Drive force is supplied by the power drive unit 30 and is transferred to the actuators 26, 26′, 28, and 28′ via the complex connection of torque shafts and gear boxes 38-66. Further, there is no inner connection between the actuators of each pair (e.g., 26, 26′) connected to one of the flaps (e.g., 22). As such, if one actuator (e.g., 26) of the two the pair of actuators (e.g., 26, 26′) experiences a mechanical problem, there is a chance that force will be transferred to the flap (e.g., 22) via only one of the actuators. As such, skewing of the flap (e.g., 22) may occur. Also, because of the interconnection of all of the actuators 26, 26′, 28, and 28′ to the single power drive unit 30, there may be complication and/or difficulty associated with a locking function that occurs at one of the flaps.

Turning back to the example system 10 shown within FIG. 1, distinctions and advantages of the present invention may now be better appreciated. The arrangement 12 has a movable flap 68 and two actuators 70, 72. The actuators 70, 72. have some identical structural features, and identical structural features are identified with identical numbers but with different the alphabetic suffixes (“A” and “B”). As such, only the first actuator 70 is discussed in detail, with the understanding that the second actuator 72 has the same structural features. However, it is to be appreciated that the actuators 70, 72 may have different structures without departing from the present invention.

The actuator 70 has a portion 74A fixed relative to a support structure 76 of the aircraft wing (e.g., structure 76 is part of the wing). A portion 78A of the actuator 70 is movable relative to the fixed portion 74A and is operatively connected to the flap 68 for transfer of motive force to the flap upon movement of the movable portion 78A. The actuator 70 includes a motor 80A for moving the movable portion 78A relative to the fixed portion 74A. As such, the actuator 70 is self-powered. It is to be recalled that the actuators 26, 26′, 28, and 28′ of the system 20 shown in FIG. 2 are powered by the remotely located power drive unit 30.

The motor 80A (FIG. 1) is electrically connected to an electronic controller 82 to receive control signals therefrom. The electronic controller 82 may be operatively connected to receive sensory or diagnostic information from the motor 80A. As such, the electronic controller can acquire data for use in signaling operational conditions and/or later diagnostics.

In the illustrated example, the motor of each actuator 70, 72 (i.e., the four actuators shown in the example) are electrically similarly connected to the controller 82. As such, the controller 82 may be thought of as being a common or shared controller. The shared electronic controller 82 is the extent of the inner-connection between the two arrangements 12. However, it should be appreciated that separate electronic controllers may be utilized for each of the arrangements 12. Overall, the two arrangements 12 are mechanically independent. Specifically, a mechanical interconnection, via the use of torque shafts and gear boxes, between the two arrangements 12 is not present.

A device 84 interconnects the two actuators 70, 72 in order to transfer motive force between the two actuators. Specifically, the device 84 can transfer force to cause movement of a respective one of the movable portions 78A or 78B. In the illustrated example, the device 84 is an elongate torque shaft.

In operation, the electronic controller 82 provides a signal to the motors 80A, 80B at both of the actuators 70, 72. Within each actuator (e.g., 70), the motor (e.g., 80A) causes the movable portion (e.g., 78A) to move. As such, motive force is transferred from both of the actuators 70, 72 to the flap 68 to cause movement of the flap. The torque shaft 84 interconnecting the two actuators 70, 72 is moved (e.g., rotated) in response to the motive force provided by both of the motors 80A, 80B at the two actuators. However, if the motor (e.g., 80B) of one of the actuators (e.g., 72) ceases to operate and thus does not provide motive force, the torque shaft 84 transfers motive force from the actuator (e.g., 70) having the operative motor (e.g., 80A) to the actuator (e.g., 72) with the inoperative motor. The transferred motive force causes the movable portion (e.g., 78B) of the actuator (e.g., 72, with the inoperative motor 80B) to move and thus transfer motive force to the flap 68. Accordingly, a balanced force is provided to the flap 68. This balanced force helps prevent skewing of the flap 68 in the event of operation cessation of the motor (e.g., 80B) at one of the actuators (e.g., 72).

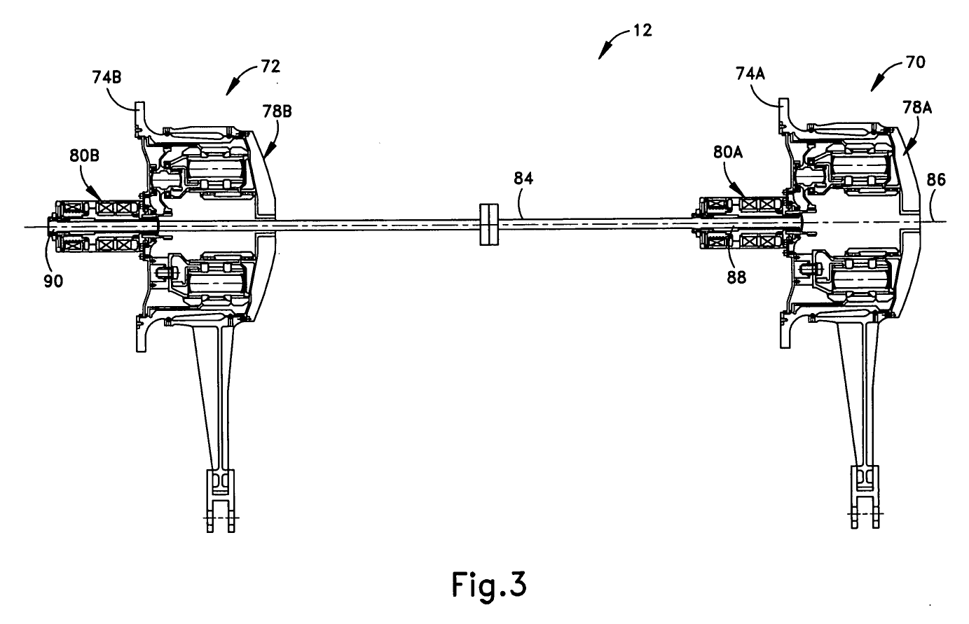

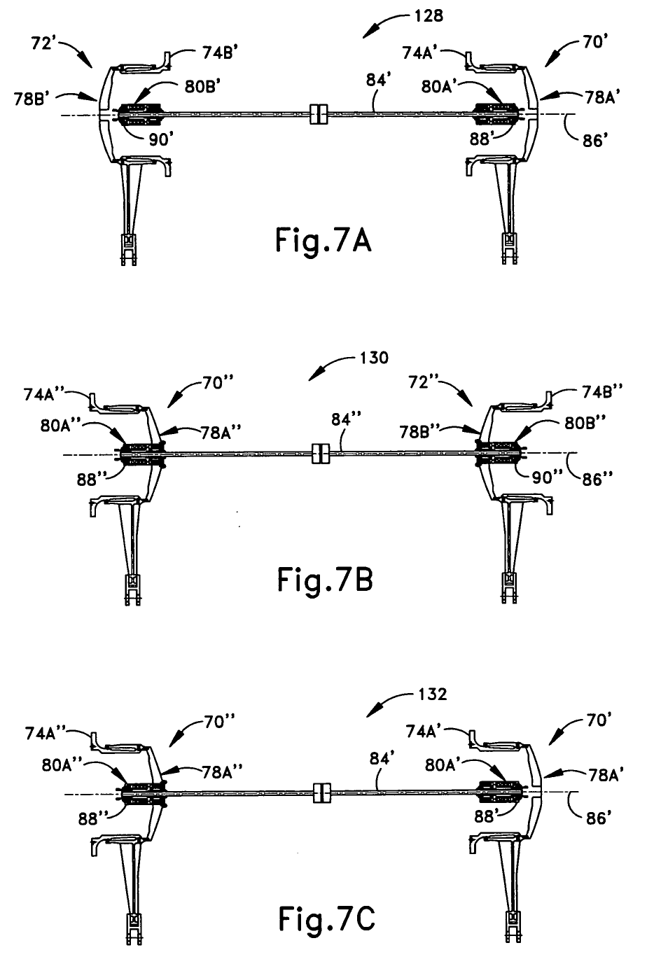

It is to be appreciated that the actuators 70, 72 may have any suitable construction and configuration so long as the construction and configuration permits the device 84 to transfer motive force between the actuators. FIG. 3 illustrates an example construction of the two actuators 70, 72 and the torque shaft 84 of the arrangement 12. The torque shaft 84 has an elongate axis 86. The first actuator 70 is located at least partially circumferentially about a first end portion 88 of the shaft 84, and the second actuator 72 is located circumferentially about a second end portion 90 of the shaft. Additionally, FIGS. 7A-7C illustrate other example constructions of other example actuators 70′, 70″, 72′, 72″ and the torque shaft 84′, 84′″ arranged in various other arrangements 128, 130, 132, as will be discussed further herein.

In one example, the actuators 70, 72 may have a construction identical or similar to the Curtiss-Wright Power Hinge™ design. The design may be provided with a removable plug on the axis, with the plug being removed to attach the shaft 84.

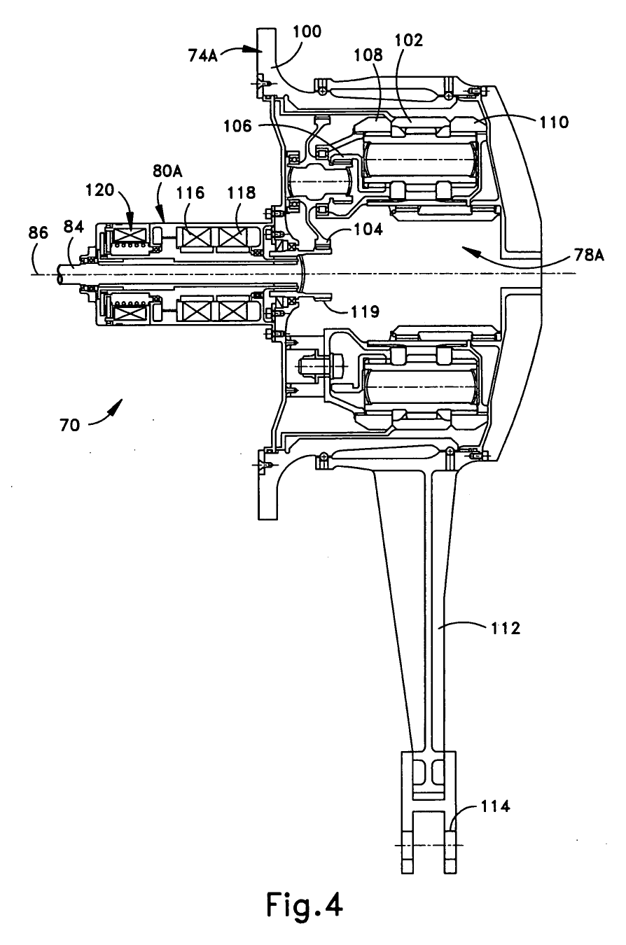

FIG. 4 illustrates specifics of an example construction of the first actuator 70. It is to be appreciated that the actuators 70, 72 may have identical construction, as is shown by the illustrated example of FIG. 3. However, the actuators 70, 72 may have certain dissimilar features without deviating from the present invention. As such, details of an example of the first actuator 70 are shown with the understanding that second actuator 72 may be identical, similar, or even different.

The fixed portion 74A of the actuator 70 includes a housing portion 100 and a stationary ring gear 102. The movable portion 78A includes several components. Some of the components are movable relative to each other. Specifically, the movable portion 78A includes a planet gear 104, a bell gear 106, and two movable ring gears 108, 110. The bell gear 106 is operatively connected to rotate with the planet gear 104 and provide the motive force to the movable ring gear 108 accordingly to the intermeshing gear ratios. The movable portion 78A also includes a connecting arm 112 that extends radially outward and has a distal portion 114 for operative connection to the flap 68. In response to the relative motion of the gears 102-110, the connecting arm 112 is caused to move in an arc about the axis 86 and thus transfer motive force to the flap as will be appreciated by the person of ordinary skill in the art.

The motor 80A in the shown example comprises two redundant, electric motor mechanisms or devices 116, 118. For example, the motor devices 116, 118 may each have a wound coil design. The motor devices 116, 118 may be either AC or DC type motor devices, dependent upon the electrical configuration of the aircraft.

The motor 80A may include other structure. For example, the motor 80A may include a brake and a sensory encoder and/or a resolver. Such additional structure is identified by reference numeral 120. As shown in the example of FIG. 4, most of the structure of the motor 80A is located axially offset from the intermeshing gears 102-110. However, it is to be appreciated that the actuator 70 may be configured such that the motor 80A is located radially inside the gears 102-110.

The motor 80A is attached to a sun gear 119. The sun gear 119 intermeshes with the planet gear 104 and thus provides the motive force to move the gears.

Turning back to the example of the arrangement 12 shown in FIG. 3, it can be seen that the first end portion 88 of the torque shaft 84 extends along the axis 86, only through motor 80A and the torque shaft and does not extend radially within the gears to any significant extent. The first end portion 88 of the shaft 84 is connected to a rotational portion of the motor 80A. The second end portion 90 of the torque shaft 84 extends along the axis 86 radially within the gears to reach the motor 80B. The second end portion 90 of the shaft 84 is connected to a rotational portion of the motor 80B.

With the torque shaft 84 operatively connected to the rotational portions of the motors 80A, 80B, rotational force (i.e., torque) is provided to the torque shaft. However, if one motor (e.g., 80B) ceases to operate, the torque shaft 84 transfers rotational force from the other motor (e.g., 80A) to the rotational portion of the nonoperational motor. In turn, the motive force is transferred to the gear train (e.g., intermeshing gears 102-110) connected to the nonoperational motor as if the motive force is generated by the nonoperational motor.

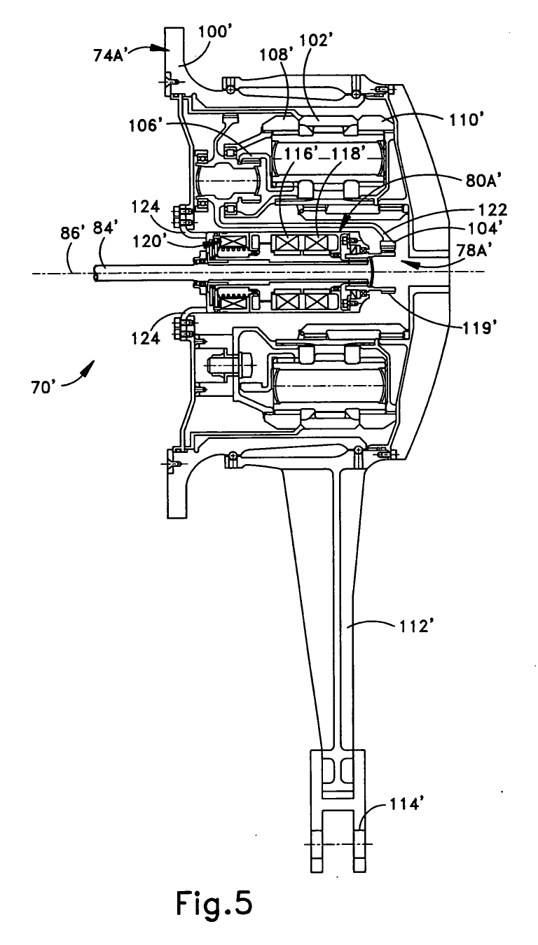

Turning now to FIG. 5, the specifics of another example construction of the first actuator 70′ is illustrated. It is to be appreciated that the specifics of the this example construction can include portions that are identical or similar to that of the prior example construction discussed above. To indicate the identical or similar structure, identical reference numerals, which have the “′” designation, are utilized. The actuators 70′, 72′ of this example may have identical construction, or they may have certain dissimilar features without deviating from the present invention. As such, details of an example of the first actuator 70′ are shown with the understanding that second actuator 72′ may be identical, similar, or even different.

The fixed portion 74A′ of the actuator 70′ includes a housing portion 100′ and a stationary ring gear 102′. The movable portion 78A′ includes several components. Some of the components are movable relative to each other. Specifically, the movable portion 78A′ includes a planet gear 104′, a bell gear 106′, and two movable ring gears 108′, 110′. The bell gear 106′ is operatively connected to rotate with the planet gear 104′ and provide the motive force to the movable ring gear 108′ accordingly to the intermeshing gear ratios. The movable portion 78A′ also includes a connecting arm 112′ that extends radially outward and has a distal portion 114′ for operative connection to the flap 68′. In response to the relative motion of the gears 102′-110′, the connecting arm 112′ is caused to move in an arc about the axis 86′ and thus transfer motive force to the flap as will be appreciated by the person of ordinary skill in the art.

The motor 80A′ in the shown example comprises two redundant, electric motor mechanisms or devices 116′, 118′. For example, the motor devices 116′, 118′ may each have a wound coil design. The motor devices 116′, 118′ may be either AC or DC type motor devices, dependent upon the electrical configuration of the aircraft.

As shown in the example of FIG. 5, the motor 80A′ can be disposed substantially completely within the actuator 70′. Accordingly, it is possible for the actuator 70′ to occupy a reduced overall volume. Thus, as shown, the majority of the motor 80A′ can be disposed within the actuator 70′, though it is to be appreciated that a portion may be disposed outside of the actuator 70′, such as, for example, mounting structure 124.

As discussed above, the motor 80A′ is attached to a sun gear 119′ that intermeshes with the planet gear 104′ to provide the motive force to move the gears. However, to accommodate the orientation of the motor 80A′, the planet gear 104′ can include an elongated portion 122 adapted to enable it to intermesh with the sun gear 119′. In addition or alternatively, additional structure and/or gears can be added to the gears 102-110′ to operatively intermesh the planet gear 104′ with the sun gear 119′.

The motor 80A′ may include other structure as discussed previously herein. For example, the motor 80A′ may include a brake and a sensory encoder and/or a resolver as is identified by reference numeral 120′. As discussed above, the motor 80A′ can include additional mounting structure 124, such as, for example, a flange, adapted to mount the motor 80A′ to the housing portion 100′ of the actuator 70′. It is to be appreciated that the additional mounting structure 124 can be attached to the motor 80A′ in various manners, or it can even be formed therewith.

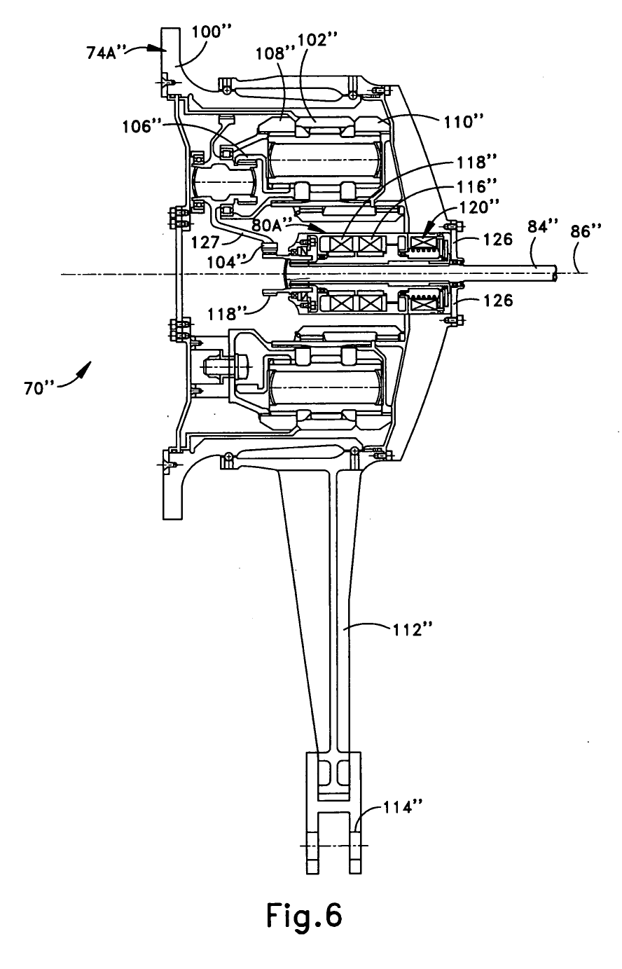

Turning now to FIG. 6, the specifics of yet another example construction of the first actuator 70″ is illustrated. It is to be appreciated that the specifics of the this example construction can include portions that are identical or similar to that of the prior example constructions discussed above. As before, to indicate the identical or similar structure, identical reference numerals, which have the “″” designation, are utilized. Again, as before, the actuators 70″, 72″ this example may have identical construction, or they may have certain dissimilar features without deviating from the present invention. As such, details of an example of the first actuator 70″ are shown with the understanding that second actuator 72″ may be identical, similar, or even different.

The fixed portion 74A″ of the actuator 70″ includes a housing portion 100″ and a stationary ring gear 102″. The movable portion 78A″ includes several components. Some of the components are movable relative to each other. Specifically, the movable portion 78A″ includes a planet gear 104″, a bell gear 106″, and two movable ring gears 108″, 110″. The bell gear 106″ is operatively connected to rotate with the planet gear 104″ and provide the motive force to the movable ring gear 108″ accordingly to the intermeshing gear ratios. The movable portion 78A″ also includes a connecting arm 112″ that extends radially outward and has a distal portion 114″ for operative connection to the flap 68″. In response to the relative motion of the gears 102-110″, the connecting arm 112″ is caused to move in an arc about the axis 86″ and thus transfer motive force to the flap as will be appreciated by the person of ordinary skill in the art.

The motor 80A″ in the shown example comprises two redundant, electric motor mechanisms or devices 116″, 118″. For example, the motor devices 116″, 118″ may each have a wound coil design. The motor devices 116″, 118″ may be either AC or DC type motor devices, dependent upon the electrical configuration of the aircraft.

As shown in the example of FIG. 6, the motor 80A″ can be disposed substantially completely within the actuator 70″. Accordingly, it is possible for the actuator 70″ to occupy a reduced overall volume. Thus, as shown, the majority of the motor 80A″ can be disposed within the actuator 70″, though it is to be appreciated that a portion may be disposed outside of the actuator 70″, such as, for example, mounting structure 126.

Again, as discussed above, the motor 80A″ is attached to a sun gear 119″ that intermeshes with the planet gear 104″ to provide the motive force to move the gears. In addition or alternatively, additional structure and/or gears can be added to the gears 102″-110″ to operatively intermesh the planet gear 104″ with the sun gear 119″. For example, the planet gear 104″ can include an elongated portion 127 adapted to enable it to intermesh with the sun gear 119″.

Further, as shown, the motor 80A″ can be configured to be attached to the movable portion 78A″ of the actuator 70″. Thus, the portion of the motor 80A″ attached to the movable portion 78A″ can move together with the connecting arm 112″, and relative to the sun gear 119″. It is to be appreciated that the motor 80A″ can also include structure (not shown) adapted to enable it to remain operatively connected to the controller 82 to receive power and transmit information. For example, the motor 80A″ can include various cables and connectors adapted to rotate with the motor 80A″ through the full range of motion of the movable portion 78A″.

The motor 80A″ may include other structure as discussed previously herein. For example, the motor 80A″ may include a brake and a sensory encoder and/or a resolver as is identified by reference numeral 120″. As mentioned above, the motor 80A″ can include additional mounting structure 126, such as, for example, a flange, adapted to mount the motor 80A″ to the movable portion 78A″ of the actuator 70″. It is to be appreciated that the additional mounting structure 126 can be attached to the motor 80A″ in various manners, or it can even be formed therewith.

Turning now to FIGS. 7A-7C, examples other arrangements 128-132 are shown. It is to be appreciated that in the examples shown, several elements, such as the various gear trains, are not depicted for clarity. It can be seen that the first end portion 88′, 88″ of the torque shaft 84′, 84″ extends along the axis 86′, 86″ and through the motor 80A′, 80A″. Additionally, the torque shaft 84′, 84″ can also extend radially within the gears. The first end portion 88′, 88″ of the shaft 84′, 84″ is connected to a rotational portion of the motor 80A′, 80A″. The second end portion 90′, 90″ of the torque shaft 84′, 84″ extends along the axis 86′, 86″ radially within the gears to reach the motor 80B′, 80B″. The second end portion 90′, 90″ of the shaft 84′, 84″ is connected to a rotational portion of the motor 80B′, 80B″. It is to be appreciated that the torque shaft 84′, 84″ can be substantially similar to that shown in accordance with the previously discussed arrangement 12, though it can also include fewer or additional elements as may be required by the other example arrangements 128, 130, 132.

Further, as discussed previously herein, with the torque shaft 84′, 84″ operatively connected to the rotational portions of the motors 80A′, 80A″, 80B′, 80B″, rotational force (i.e., torque) is provided to the torque shaft. However, if one motor (e.g., 80B′) ceases to operate, the torque shaft 84′ can transfer rotational force from the other motor (e.g., 80A′) to the rotational portion of the nonoperational motor. In turn, the motive force can be transferred to the gear train (e.g., intermeshing gears 102′-110′) connected to the nonoperational motor as if the motive force is generated by the nonoperational motor.

It is to be appreciated that various constructions of the actuators 70′, 70″ and 72′, 72″ can be used in the various example arrangements 128-132. For example, as shown in FIG. 7A, one example arrangement 128 can utilize one actuator 70′ as shown in FIG. 5 connected through the torque shaft 84′ to a substantially identical actuator 72′ that has been rotated 180 degrees. Similarly, as shown in FIG. 7B, another example arrangement 130 can utilize one actuator 70″ as shown in FIG. 6 connected through the torque shaft 84″ to a substantially identical actuator 72″ that has been rotated 180 degrees. Further still, as shown in FIG. 7C, yet another example arrangement 132 can use one actuator 70′ as shown in FIG. 5 connected through the torque shaft 84′ to another actuator 70″ as shown in FIG. 6. It is to be appreciated that the example arrangements 12, 128, 130, 132 are not intended to provide a limitation upon the present invention, and that various combinations of actuators 70, 70′, 70″ and 72, 72′, 72″ can be arranged in various arrangements.

Of course, different actuator construction may result in a different connection of the torque shaft to such different actuators. For example, if the motor is located radially within the gear train of the actuator, the torque shaft would extend accordingly and be appropriately connected. Also, it is contemplated that the torque shaft may be connected in a different manner to the actuators to transfer motive force between the two actuators. For example, the torque shaft may be directly connected into a gear train at each of the actuators.

As such, several benefits are provided by the present invention. All of the structure associated with transfer of motive force from a single, remotely-located power drive unit is eliminated. For example, the present invention eliminates the need for excessive torque shafts and gear boxes connecting various actuators with a single power drive unit. With the elimination of such structure, there is an elimination of associated structure such as torque shaft support bearings. Complicated, passive ball screw actuators are not needed because the motive force is provided right at the actuators.

In fact, the present invention eliminates the need for a single power drive unit via the use of motors at each of the actuators. Also, the ability to transfer motive force between two actuators eases the need for a redundant motive system (e.g., both electric and hydraulic) at a single power drive unit. Such need for redundancy (e.g., electric and hydraulic) is further eased via the presence of dual electrical components at each of the actuator motors.

Additionally, because the motors 80A′, 80A″ can be disposed substantially completely within the actuators 70′, 70″, as shown in the examples of FIGS. 5-6, it is possible for the actuators 70′, 70″ to occupy a reduced overall volume. This can be beneficial when the arrangement 128, 130, 132 is for a flight vehicle, such as an aircraft. For example, the arrangement 128, 130, 132 can be located within the interior of an aircraft wing, which can be very limited. Thus, it can be beneficial for the actuator 70′, 70″ to have an efficient design with respect to its overall volume.

The actuator and flap arrangement in accordance with the present invention helps prevent skewing at the flap due to different driving forces caused by a problem at one of the actuators. The arrangement in accordance with the present invention permits the cessation of movement of one of the flaps (e.g., even including locking the flap) without affecting operation of other, adjacent flaps.

Flap actuation arrangements according to the present invention may be utilized for flaps on either trailing edge or leading edge horizontal wing designs. The flap actuators may be utilized for vertical orientated flaps.

Within the discussed example, the system is discussed with regard to use within an aircraft. As such, the flaps provide changes in fluid force against air as the fluid. For example, the flap may provide lift. However, it is to be appreciated that application of the present invention is not limited to aircraft. For example, some other vehicles require flaps that move relative to a fixed structure and thereby change force against which the adjacent fluid pressure is changed. Such a vehicle may also be involved with direction of fluid force where air is the fluid, or may be used to direct force in other fluids such as water.

From the above description of the invention, those skilled in the art will perceive improvements, changes and modifications. Such improvements, changes and modifications within the skill of the art are intended to be covered by the appended claims.

1. An actuator and flap arrangement including:
a flap movable relative to a supporting structure;
two rotary actuators electrically connected to and responsive to only a single, non-redundant electronic controller, each actuator having a portion fixed relative to the support structure, each actuator having a portion movable relative to the fixed portion and connected to the flap for transfer of motive force to the flap upon movement of the movable portion, and each actuator having its own electric motor integrated into the respective actuator to provide primary motive force for moving the movable portion relative to the fixed portion such that the respective actuator is self powered; and
a device interconnecting the two actuators for transferring rotational motive force between the two actuators.

2. An arrangement as set forth in claim 1, wherein at least one of the electric motors is disposed substantially completely within at least one of the actuators.

3. An arrangement as set forth in claim 2, wherein at least one of the motors is attached to the fixed portion of one of the actuators.

4. An arrangement as set forth in claim 2, wherein at least one of the motors is attached to the movable portion of one of the actuators to rotate therewith.

5. An arrangement as set forth in claim 1, wherein the interconnecting device includes a torque shaft.

6. An arrangement as set forth in claim 1, wherein the interconnecting device transfers motive force from one of the actuators to the other of the actuators upon cessation of the motor at the one of the actuators.

7. An arrangement as set forth in claim 1, wherein for each actuator, the movable portion includes a connecting arm pivotally connected to the flap.

8. An arrangement as set forth in claim 1, wherein for each actuator, the fixed portion includes a housing and a ring gear, the movable portion includes a ring gear, a bell gear, and a plurality of planet gears, and the motor includes a sun gear.

9. An arrangement as set forth in claim 8, wherein for each actuator, the motor, the sun gear, the fixed ring gear, and the movable ring gear are coaxial with the connection with the interconnecting device.

10. An arrangement as set forth in claim 9, wherein for at least one of the actuators, the interconnecting device extends through the fixed ring gear and the movable ring gear.

11. An arrangement as set forth in claim 9, wherein for at least one of the actuators, the interconnecting device extends through the motor.

12. An arrangement as set forth in claim 8, wherein at least one of the actuators is configured such that the interconnecting device extends through an area generally bounded by the housing, the ring gears, the bell gear, the plurality of planet gears, and the sun gear

13. An arrangement as set forth in claim 1, wherein the arrangement is for a flight vehicle, and the flap provides directional fluid flow for the vehicle.

14. An arrangement as set forth in claim 1, wherein the arrangement is configured such that the actuators are controlled without force fight between the actuators.

15. An arrangement as set forth in claim 1, wherein no separate gear box is used to transfer force.

16. An arrangement as set forth in claim 1, wherein no flexible drive shaft is used to transfer force.

17. An arrangement as set forth in claim 1, wherein the interconnecting device is a torque shaft that is directly connected between the electric motors.

18. An arrangement as set forth in claim 1, wherein for each motor, the motor is a rotary electric motor, and for each rotary actuator with its rotary electric motor a single common rotation axis is provided.

19. An arrangement as set forth in claim 1, wherein the interconnecting device is not part of any structure used to transmit primary motion force to either of the rotary actuators.

20. An arrangement as set forth in claim 1, wherein at least one of the actuators is configured such that the interconnecting device extends through the actuator.

21. An arrangement as set forth in claim 1, wherein the actuators are configured such that the interconnecting device extends at least partially through the actuators.

22. An arrangement as set forth in claim 1, wherein at least one of the actuators is configured such that the interconnecting device extends through the electric motor of the actuator.

23. An actuator and flap arrangement including:
a flap movable relative to a supporting structure;
two rotary actuators responsive to only a single, non-redundant electronic control source, each actuator having a portion fixed relative to the support structure, each actuator having a portion movable relative to the fixed portion and connected to the flap for transfer of motive force to the flap upon movement of the movable portion, and each actuator having its own electric motor integrated into the respective actuator to provide primary motive force for moving the movable portion relative to the fixed portion such that the respective actuator is self powered; and
a device interconnecting the two actuators for transferring rotational motive force between the two actuators, wherein at least one of the actuators is configured such that the interconnecting device extends through the actuator.

24. An arrangement as set forth in claim 23, wherein at least one of the electric motors is disposed substantially completely within at least one of the actuators.

25. An arrangement as set forth in claim 23, wherein the at least one of the actuators is a first actuator and the other actuator is a second actuator, the second actuator is configured such that the interconnecting device extends at least partially through the second actuator.

26. An arrangement as set forth in claim 23, wherein at least one of the electric motors is configured such that the interconnecting device extends through the electric motor.

27. An arrangement as set forth in claim 26, wherein both of the electric motors are configured such that the interconnecting device extends through the electric motors.

28. An arrangement as set forth in claim 26, wherein the interconnecting device is a torque shaft.

29. An arrangement as set forth in claim 23, wherein the two rotary actuators are electrically connected to the electronic controller.

30. An actuator and flap arrangement including:
a flap movable relative to a supporting structure;
two rotary actuators responsive to a single control source, each actuator having a portion fixed relative to the support structure, each actuator having a portion movable relative to the fixed portion and connected to the flap for transfer of motive force to the flap upon movement of the movable portion, and each actuator having its own electric motor integrated into the respective actuator to provide primary motive force for moving the movable portion relative to the fixed portion such that the respective actuator is self powered, wherein at least one of the electric motors is disposed substantially completely within at least one of the actuators; and
a device interconnecting the two actuators for transferring rotational motive force between the two actuators.

31. An arrangement as set forth in claim 30, wherein each electric motor is disposed substantially completely within each actuator.

32. An arrangement as set forth in claim 30, wherein at least one of the motors is attached to the fixed portion of one of the actuators.

33. An arrangement as set forth in claim 30, wherein at least one of the motors is attached to the movable portion of one of the actuators to rotate therewith.

34. An arrangement as set forth in claim 33, wherein the movable portion of each actuator includes a ring gear, a bell gear, and a plurality of planet gears, and the motor includes a sun gear, and wherein a portion of the motor attached to the movable portion is configured to rotate relative to the sun gear.

35. An arrangement as set forth in claim 30, wherein the control source is an electronic controller, and the two rotary actuators are electrically connected to the electronic controller.

36. An arrangement as set forth in claim 30, wherein the interconnecting device includes a torque shaft.

37. An arrangement as set forth in claim 30, wherein the actuators are configured such that the interconnecting device extends at least partially through the actuators.

38. An arrangement as set forth in claim 30, wherein at least one of the actuators is configured such that the interconnecting device extends through the electric motor of the actuator.
